(19) United States
(12) Patent Application Publication
(10) Pub. No.: US 2014/0345290 A1
(43) Pub. Date: Nov. 27, 2014

(54) METHOD FOR STABILIZING A GRID FREQUENCY WITH A GAS TURBINE IN MIXED FUEL OPERATION

(71) Applicant: Siemens Aktiengesellschaft, Munich (DE)

(72) Inventors: Andreas Heilos, Mulheim an der Ruhr (DE); Holger Hesse, Berlin (DE); Marc Schafer, Mulheim an der Ruhr (DE)

(73) Assignee: Siemens Aktiengesellschaft, Munich (DE)

(21) Appl. No.: 14/363,767

(22) PCT Filed: Nov. 15, 2012
(86) PCT No.: PCT/EP2012/072741

§ 371 Date: Jun. 6, 2014

(30) Foreign Application Priority Data
Dec. 14, 2011 (DE) 10 2011 088 524.2

(51) Int. Cl. F02C 9/26

(52) U.S. Cl. CPC F02C 9/26
USPC 60/772

(57) ABSTRACT

A method for stabilising a network frequency with a gas turbine that can be operated using syngas and an additional fuel is provided. The mass-flow of the additional fuel, supplied to operate the gas turbine, can be increased more quickly than that of the syngas and, in order to stabilise a network frequency, a ratio of the mass-flow of syngas to that of the additional fuel, for operating said gas turbine, is modified by the mass-flow of said additional fuel being modified while the mass-flow of the syngas remains the same.

### CROSS REFERENCE TO RELATED APPLICATIONS

This application is the US National Stage of International Application No. PCT/EP2012/072741 filed Nov. 15, 2012, and claims the benefit thereof. The International Application claims the benefit of German Application No. DE 102011088524.2 filed Dec. 14, 2011. All of the applications are incorporated by reference herein in their entirety.

### FIELD OF INVENTION

The invention relates to a method for stabilizing a grid frequency with a gas turbine in mixed-fuel operation, in particular in (mixed) operation with syngas.

### BACKGROUND OF INVENTION

It has not previously been possible to use syngas-operated gas turbines for frequency support.

### SUMMARY OF INVENTION

An object of the invention is therefore to provide a method by which gas turbines with mixed operation can also participate in stabilizing the grid frequency.

The invention achieves this object by providing that, in the case of such a method for stabilizing a grid frequency with a gas turbine that can be operated with syngas and a further fuel, wherein the mass flow of the further fuel that is provided for the operation of the gas turbine can be increased more quickly than that of the syngas, a ratio of the mass flows of the syngas to the further fuel for the operation of the gas turbine is modified to stabilize a grid frequency, in that the mass flow of the further fuel is modified and the mass flow of the syngas remains the same.

While the amount of syngas generated cannot be modified quickly enough to allow power gradients of interest for frequency support to be operated because of process engineering restrictions of the gasifiers, the amount of secondary fuel can usually be increased or reduced quickly.

Instead of the previous practice of keeping the fuel split constant and uniformly increasing or reducing the amounts of all the fuels involved, it is now intended that the amount of syngas remains constant and the power variation is achieved by quickly raising or lowering the mass flow of the secondary fuel alone.

It is advantageous if natural gas is burned as the further fuel.

Alternatively, it may be advantageous if heating oil is burned as the further fuel.

With the method according to the invention, frequency support is now also possible in the case of syngas-fired gas turbines. The amount of syngas is prescribed as a fixed value by the operator of the installation, while the amount of the second fuel is adapted to correspond to the power required by the grid.

Alternatively, the mass flow of the syngas may be adjusted to the power requirement more slowly than the second fuel, the mass flow of the second fuel being adapted correspondingly, so that a pre-set fuel split can be restored.

### BRIEF DESCRIPTION OF THE DRAWINGS

The invention is explained in more detail by way of example on the basis of the drawings, which are schematic and not to scale and in which:

FIG. 1 shows a power requirement from the electricity grid and

FIG. 2 shows the modulation of the fuel mass flow of the second fuel to follow the grid requirements while the amount of syngas remains the same.

### DETAILED DESCRIPTION OF INVENTION

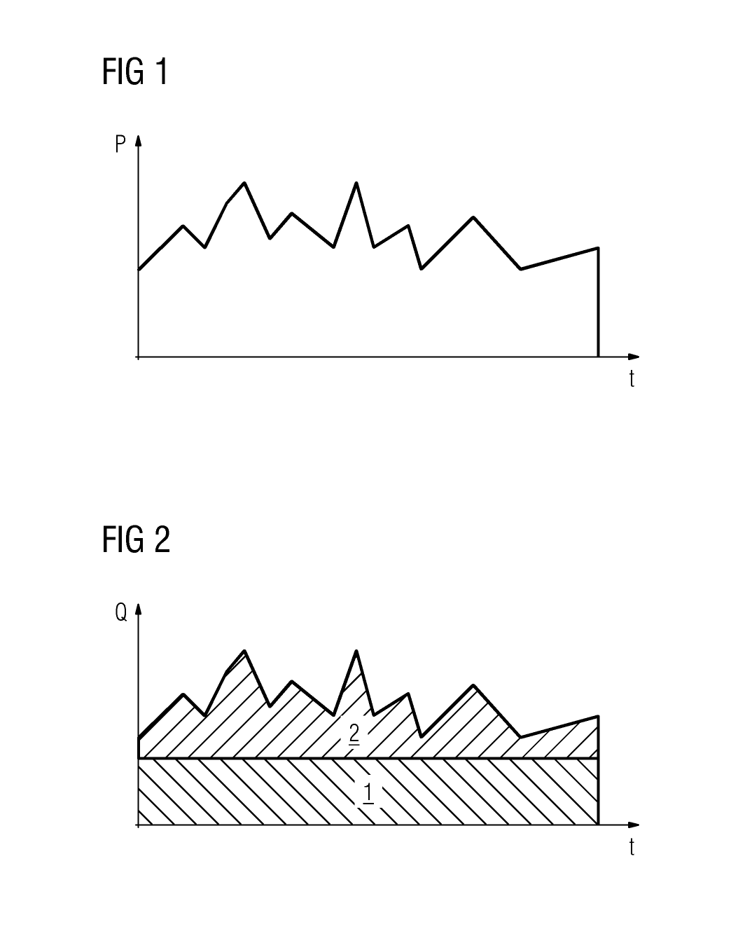

FIG. 1 shows by way of example a power requirement from the electricity grid over time and FIG. 2 shows the corresponding fuel mass flows. According to aspects of the invention, the mass flow of the syngas 1 remains constant, irrespective of the power requirement, and the mass flow of the second fuel 2 follows the variation in the power requirement from the electricity grid.

1. A method for stabilizing a grid frequency with a gas turbine that can be operated with syngas and a further fuel, wherein the mass flow of the further fuel that is provided for the operation of the gas turbine can be increased more quickly than that of the syngas comprising
modifying a ratio of the mass flows of the syngas to the further fuel for the operation of the gas turbine to stabilize a grid frequency, wherein the mass flow of the further fuel is modified and the mass flow of the syngas remains the same.

2. The method as claimed in claim 1, wherein natural gas is burned as the further fuel.

3. The method as claimed in claim 1, wherein heating oil is burned as the further fuel.
